(19) United States
(12) Patent Application Publication
(10) Pub. No.: US 2025/0250759 A1
(43) Pub. Date: Aug. 7, 2025

(54) Square Drive Anchor Adapter Tool

(71) Applicant: Steven L Wojtaszek, Midland, MI (US)

(72) Inventor: Steven L Wojtaszek, Midland, MI (US)

(21) Appl. No.: 19/034,123

(22) Filed: Jan. 22, 2025

Related U.S. Application Data
(60) Provisional application No. 63/549,662, filed on Feb. 5, 2024.

(51) Int. Cl. E02D 7/14; B25F 3/00

(52) U.S. Cl. CPC E02D 7/14; B25F 3/00

(57) ABSTRACT

A device which allows a square shaft earth anchor to be adapted to allow a standard connection to commonly available powered rotary tools.

### BACKGROUND OF THE INVENTION

A common device for securing or supporting structures to their surroundings is the ground (earth) helical anchor, also referred to as “helical piles.” Many designs are of the helical flight types which require the anchors to be installed by rotating them into the medium (typically earth ground) to function. This rotation can be accomplished with a lever traditionally in the form of a steel bar or wood member which connects to the top of the anchor allowing a user to install the anchor with human effort (by hand) for anchors and ground condition combinations which afford this method.

In the case of anchors used for securing and/or supporting structures such as decks or used to suspend structures off the ground a common design incorporates a provision to cradle structural members to the anchor. This design also allows for the insertion of a typical dimensional wood such as a “2×4” which can be used as a lever to rotate and install the anchor into the desired location.

While this “manual” method to install anchors is effective, a less physically demanding and more time efficient option to the installer is to drive the anchors in with a commonly available powered tool such as an impact wrench, drill, or other powered rotating equipment, or even a manual tool that does not need to be removed to be such as with a ratchet wrench. All of these methods are considered to be examples of “prime movers.”

In order to maintain the ultimate design intention of the anchor to support the structure, and to accommodate the many existing anchors which may need to be reclaimed or reused, an adapter tool can be constructed which allows a user to connect to the anchor while also providing a standard connection to the powered rotational tools listed in [003].

The objective of the anchor adapter tool is to afford the installer the ability to temporarily connect to anchors which do not already have the ability to support standard connections. Once the anchor is installed using the adapter tool, it can be removed to utilize the anchor in its intended fashion.

Further benefits include being compact, lightweight, and having a low profile which allows the tool to be easily placed into and removed from the anchor even if it is in a location which would make larger components difficult to place in and take out of the anchor.

The adapter is intended to be able to be installed and removed quickly by freely sliding over the square end of the anchor or pile. Provisions such as pins or friction increasing add-ons can be included to prevent the adapter from freely sliding if desired by the user in cases where axial force can facilitate more effective installation or removal of the anchor or pile.

In order to effectively transmit the torsion from the prime mover, clearances are preferred to be minimized between the tool and connections but still allow connection and disconnection the tool without the use of additional tools or devices; that is by more than can be provided by the average user “by hand.” Additionally, the tool provides concentric alignment between the output of the prime mover and the anchor or pile shaft.

### SUMMARY OF THE INVENTION

In its very basic form, the anchor adapter consists of a rigid frame capable of withstanding the anticipated loading and able to be attached to the anchor by being slid onto the square section of the anchor. The anchor adapter is equipped with standard drive connection concentrically locating it with respect to the anchor or pile shaft axis, which allows installers to choose the preferred primer mover(s) to be used such as those mentioned in [003].

The adapter tool could be used both in an impacting and non-impacting fashion with appropriate design capabilities and provisions for each.

### BRIEF DESCRIPTION OF THE DRAWINGS

FIG. 1 is a view of the general layout of the tool which would connect to a typical helical anchor or pile having a square shaft at its end. FIGS. 1A, B, C, D, E show each side of the invention including an isometric view (FIG. 1E.)

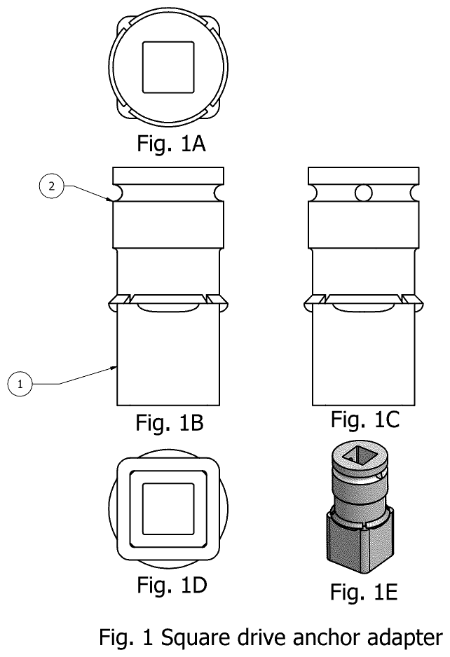

### DETAILED DESCRIPTION OF THE PREFERRED EMBODIMENT

The preferred embodiment consists of a frame with two ends. One end to connect the anchor or pile to 2 and one end to connect to the prime mover 1 constructed of material of sufficient strength such a low carbon steel or steels with additives to develop resistance to failure from fatigue from impact or high stresses. The unit is either a weldment of components or one continuous cast or forged piece. Clearances between the adapter tool connections should allow the tool to slide on and off axially with only the effort to install or remove the tool by hand, but also be minimized to effectively transmit torsion from the chosen prime mover into the anchor or pile.

1. An adapter tool comprising a connection to a helical earth anchor or pile of the type having a helical flight(s) and consisting of a standard common connection receiver at one end of the unit and a hollow square member at the opposite end for connection to the earth anchor or pile.

2. The device of claim 1, wherein the standard common connection is of the square or hexagonal type for use with rotary tools equipped with square drives or drill chucks.

3. The device of claim 1, wherein the hollow square member is sized to freely slide over the square end of the anchor or pile while providing minimal rotational clearance on all sides necessary to achieve the ability to freely slide.

4. The device of claims 3 and 4, wherein the tool provides a concentric connection between the longitudinal axis of prime mover output connection and the longitudinal axis of the anchor or pile shaft.
